(19) United States
(12) Patent Application Publication
(10) Pub. No.: US 2011/0016960 A1
(43) Pub. Date: Jan. 27, 2011

(54) Device For Detecting Angular Position, Electric Motor, Steering Column And Reduction Gear

(76) Inventor: Franck Debrailly, Nouzilly (FR)

Correspondence Address: SKF USA Inc., 890 Forty Foot Road, PO Box 352, Lansdale, PA, 19446, US

(21) Appl. No.: 12/225,078

(22) PCT Filed: Mar. 13, 2007
(86) PCT No.: PCT/FR2007/005017

§ 371 Date: Sep. 16, 2010

(51) Int. Cl. G01M 19/00

(52) U.S. Cl. 73/115.07

(57) ABSTRACT

Device 1 for detecting the angular position of a shaft of an electric motor relative to a nonrotating element, comprising a reduction gear 5 comprising an input connected in rotation to the shaft 2, and an output such that the output of the reduction gear 5 moves over an angle of less than 2π, a single-revolution angular position sensor 26 being placed to measure the angle of the output of the reduction gear 5 and an angular position sensor 27 being placed on the input of the reduction gear 5.

The present invention relates to the field of angular position detection of an electric motor shaft.

The present invention also relates to the field of motor vehicle steering columns, wherein it is desired to ascertain the angular position with precision.

Specifically, vehicles are increasingly making use of electric power assisted steering devices and sensors of the deflection angle of the steering column in order to determine the angle of the wheels and thereby act on the brakes for the trajectory corrections. Electric power assisted steering devices frequently use brushless direct current electric motors whose switching actions it is necessary to control closely and therefore for which it is necessary to know the absolute angular position of the rotor. Power assistance electric motors therefore actuate the system of orientation of the zones with which they are mechanically connected. Depending on the types of vehicles and the manufacturers, the mechanical connection between the power assistance motor and the wheel orientation system may be made at different possible locations, for example on the steering column shaft or else on the wheel orientation rack. In a steering column, there is usually a gear reduction between the speed of rotation of the steering column and that of the electric motor of the order of 10 to 20, such that the steering column makes one revolution while the motor shaft makes 10 to 20. The total number of revolutions for the steering column from one maximum deflection direction to another is of the order of 4 revolutions. It is therefore necessary to determine the absolute angle of the motor shaft over 40 to 80 shaft revolutions and the absolute angle of the steering column over 4 revolutions.

Document EP 1 026 068 (TRW) describes electric power assisted steering comprising a steering shaft, an electric motor having a rotor connected operationally to the steering shaft through a gearbox having a non-integer reduction ratio, first detection means for producing an output as a function of the angular position of the steering shaft and second detection means designed to produce an output as a function of the angular position of the rotor, and processing means designed to process the two output signals in order to produce an angular position signal indicating the angular position of the steering shaft over a range greater than one complete revolution. An absolute angle sensor may be provided on the motor shaft or on the steering column shaft, which is costly since it is a multirevolution absolute sensor. Furthermore, an index may be provided on the steering shaft or on the motor shaft. However, the index does not provide sufficient accuracy.

Document EP 1 413 499 (Toyoda) describes electric power assisted steering provided with two sensors on the steering column and one sensor on the motor. Having three sensors is costly and also requires relatively sophisticated processing electronics.

Document U.S. Pat. No. 5,646,523 (Kaiser) describes an apparatus for determining the angular position of deflection of wheels comprising a precise sensor and an approximate sensor which are associated with the steering column shaft, the precise sensor having a quadruple gear reduction thanks to gears making it possible to drive the corresponding encoder more quickly. This device is relatively complicated and does not make it possible to ascertain the position of the poles of the electric motor.

Document U.S. Pat. No. 6,248,993 (Leopold Kostal) describes a deflection angle sensor in order to determine the absolute angular position of deflection of a wheel, comprising two sensor units, one detecting the angular position in an angle segment of the complete range of deflection rotation, the other unit detecting the deflection rotation through gears with a ratio other than 1, such that the rotation speeds detected by the two sensors are different in order to detect an absolute angular position. There again, this document does not make it possible to ascertain the absolute angular position of the rotor of the electric drive motor.

The abstract of document JP 2005 053 416 (Toyoda Mach Works) describes a deflection apparatus for a vehicle of the fully electric steering type. The electric steering motor is associated with two reduction gears, one for the deflection of the wheels and the other for the detection of rotation with a rotation over one revolution from a neutral position, that is a total rotation over two revolutions.

The object of the present invention is to remedy the disadvantages and limitations of the above documents.

The object of the present invention is to provide by means of a single module an absolute angular position of the shaft of the electric steering motor and of the angle of deflection of the steering wheels. Usually, the angle of deflection of the steering wheels is connected in a one-to-one relationship to the angular position of the steering column.

The object of the present invention is to provide said angular positions by reliable and cost-effective means.

The device for detecting the angular position of the shaft of an electric motor relative to a rotating element comprises a reduction gear comprising an input connected in rotation to the shaft and an output, such that the output of the reduction gear moves over an angle of less than 2π, a single-revolution angular position sensor being placed in order to measure the angle of the reduction gear output, and an angular position sensor being placed on the reduction gear input. This therefore gives a reduction gear provided with an input angular position sensor and an output angular position sensor and capable when it is mounted in a steering mechanism of providing two signals making it possible to determine with sufficient accuracy the angular position of the rotor of the electric motor and the angular position of deflection of the wheels. It is therefore possible to act by assistance systems on the trajectory of the vehicle. The reduction gear fitted with its two sensors forms a subassembly that can be mounted on an electric steering electric motor of the conventional type.

The reduction ratio of the reduction gear may lie between 5 and 100.

In one embodiment, the reduction gear comprises a rolling bearing and a casing. The rolling bearing may comprise an inner race mounted on the shaft and an outer race mounted in the casing. An encoder may be supported by the inner race and interact with the angular position sensor.

In one embodiment, the single-revolution sensor is an absolute angular position sensor. A single-revolution absolute angular position sensor is markedly less costly than a multirevolution absolute angular position sensor.

In one embodiment, the single-revolution sensor is mounted on an electronic circuit board supported by a casing of the reduction gear. The two sensors may be mounted on the electronic circuit board. An encoder may be mounted on a rolling bearing.

In one embodiment, the device comprises a rolling bearing comprising a rotating inner race designed to be mounted on the shaft and a nonrotating outer race.

In one embodiment, the reduction gear comprises at least one epicyclic train. This makes it possible to obtain a reduction ratio of the order of 5 to 20.

In another embodiment, the reduction gear comprises at least one harmonic reduction gear. This makes it possible to obtain a reduction ratio lying between 15 and 100.

In one embodiment, the output is designed in torques for the drag torque of the device itself. The drag torque of the device may consist essentially of the drag torque of the rolling bearing of the reduction gear and the drag torque of the gears of the reduction gear. The drag torque of the device is very slight.

In one embodiment, the input angular position is capable of measuring a modulo 2π angle. It is therefore possible to use an economical angular position sensor of the absolute or incremental type.

In one embodiment, the shaft is connected to an element driven by gearing with a reduction ratio lying between 1 and 5.

In one embodiment, the input angular position sensor comprises a multipole encoder.

The angular position sensor may be radially outside the encoder. The single-revolution angular position sensor may have an axial air gap with an encoder.

The single-revolution angular position sensor may be placed radially outside the angular position sensor.

A sensor may comprise one or more sensitive elements placed opposite an encoder element, for example one or more Hall effect cells placed opposite a multipole magnetic encoder ring.

The electric motor comprises a rotor, a stator, a shaft supporting the rotor and a device for detecting the angular position of the shaft relative to a nonrotating element. The reduction gear comprises an input connected in rotation to the shaft, and an output. The reduction ratio of the reduction gear is chosen to be between 5 and 100 such that the output of the reduction gear moves over an angle of less than 2π. A single-revolution angular position sensor is placed to measure the angle of the output of the reduction gear and an angular position sensor is placed on the input of the reduction gear.

A power assisted steering device may comprise an electric motor as above and a shaft driven by the electric motor is provided to cause the deflection of the wheels of a vehicle.

A reduction gear may comprise a reduction mechanism, an input, an output, a single-revolution angular position sensor placed to measure the angle of the output, and an angular position sensor placed on the input, the reduction ratio of the reduction gear being chosen such that the output of the reduction gear moves over an angle of less than 2π.

The reduction gear may comprise a rolling bearing and a casing, the rolling bearing comprising an inner race designed to be mounted on a shaft, an outer race mounted in the casing, and an encoder supported by the inner race and interacting with the angular position sensor.

The present invention will be better understood on reading the detailed description of an embodiment taken as an example that is in no way limiting and is illustrated by the appended drawings, in which:

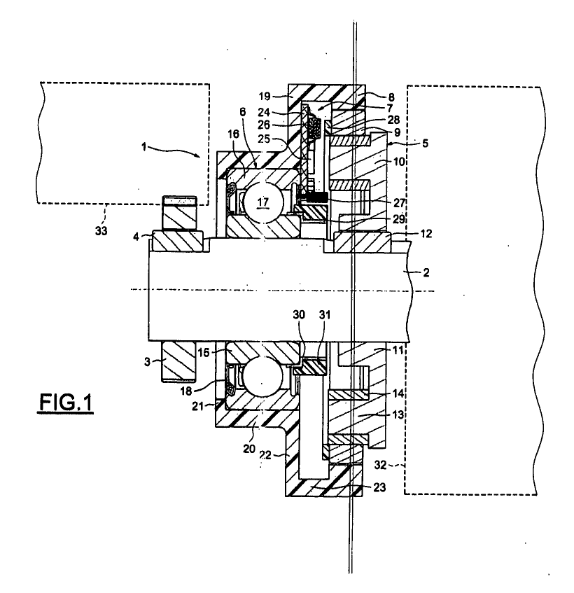

FIG. 1 is a view in axial section of an angular position detection device;

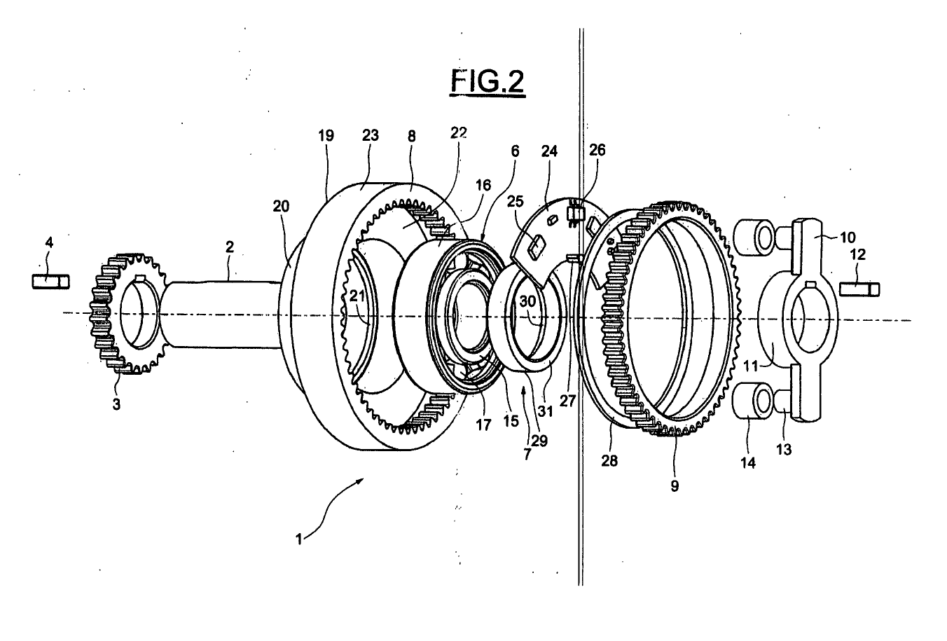

FIG. 2 is an exploded view in perspective of the device of FIG. 1; and

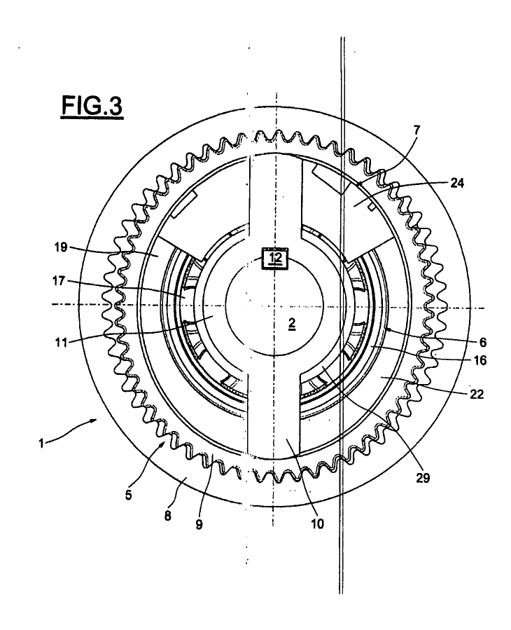

FIG. 3 is a side view in elevation of the device of FIG. 1.

As can be seen in the figures, the angular position detection device 1 is mounted on the shaft 2 of an electric motor. The shaft 2 also supports a pinion 3 keyed by a key 4 and for example designed to drive an additional gear of a steering column.

The detection device 1 comprises a reduction gear 5, in this instance of the harmonic type, a rolling bearing 6 and a detection portion 7.

The reduction gear 5 which in this instance is of the harmonic type comprises a crown wheel 8 provided with inward-facing teeth, a radially flexible gear 9 meshing with the crown wheel 8 in two diametrically opposed zones (see FIG. 3), and a wave generator 10, mounted concentrically. The flexible gear 9 is provided with an axial inner surface. The wave generator 10 comprises a ring 11 whose bore is mounted on the shaft 2 in a manner that is fixed in rotation by means of a key 12. From the ring 11 two diametrically opposed arms extend radially outward. The wave generator 10 comprises two support fingers 13 each mounted on an arm. The ring, the arms and the fingers may be in one piece. The wave generator 10 is supplemented by two smooth bushes 14 each mounted on a finger 13. The bushes 14 are in contact with the inner surface of the flexible gear 9 whose radial deformation they cause by forcing said flexible gear 9 to mesh in the teeth of the crown wheel in two diametrically opposed zones. It could be envisaged to replace the bushes 14 with bearings. The wave generator 10 is keyed onto the shaft 2 by a key 12.

The rolling bearing 6 is mounted on the shaft 2 axially between the pinion 3 and the reduction gear 5. The rolling bearing 6 comprises an inner race 15, for example sleeve-fitted onto the shaft 2, an outer race 16, an array of rolling elements 17, in this case balls, kept evenly spaced circumferentially by a cage and a sealing flange 18 mounted in a groove of the outer race 16 and forming a narrow passageway with an axial bearing surface of the inner race 15. The races 15 and 16 each have a raceway in the shape of a portion of a torus in order to receive the rolling elements 17. The races 15 and 16 are of the deep groove type. The rolling bearing 6 may be of a standard type manufactured economically in a large production run.

The detection device 1 comprises a casing 19, for example made of a synthetic material, surrounding the reduction gear 5 and the rolling bearing 6. In the embodiment illustrated, the casing 19 is annular and comprises a small diameter axial portion 20 in the bore of which the outer race 16 of the rolling bearing 6 is rigidly attached. On the side of the pinion 3, the small-diameter axial portion 20 is extended by a short radial rim 21 directed inward and in contact with a front surface of the outer race 16, thereby forming an axial stop. The casing 19 also comprises a radial portion 22 extending outward from the end of the small-diameter axial portion 20 opposite to the radial rim 21 and having a face that is substantially coplanar with the transverse radial surfaces of the inner race 15 and outer race 16 of the rolling bearing 6. The casing 19 comprises a large-diameter axial portion 23 extending axially opposite to the pinion 3 from the large-diameter end of the radial portion 22. The crown wheel is fixedly attached to the large-diameter axial portion 23.

Advantageously, the portions of the casing 19 and the crown wheel 8 are made in a one-piece manner, for example molded together. The casing 19 may be made of polyamide reinforced by a mineral filler.

The detection portion 7 is generally placed in a space axially delimited on one side by the reduction gear 5 and on the other side by the rolling bearing 6, and radially, on one side by the shaft 2 and on the other side by the large-diameter axial portion 23 of the casing 29. The detection portion 7 comprises an electronic circuit board 24 occupying a limited angular sector (see FIGS. 2 and 3), for example of the order of 90° and attached against the inner radial face of the radial portion 22 of the casing 19 and in contact with the transverse face of the outer race of the rolling bearing 16 on the side of the reduction gear 5. Alternatively, the electronic circuit board may be attached to the outer race 16 and in contact with the casing 19.

The electronic circuit board 24 supports an electronic processing circuit 25 and two sensors 26 and 27, for example of the magnetism-sensitive type. The sensor 26 is attached angularly substantially in the middle of the board 24 and radially at the flexible gear 9. The sensor 27 is attached angularly substantially in the middle of the board 24 and radially on its inner edge radially facing inward. Therefore, the sensor 26 is placed radially on the outside of the sensor 27. The sensors 26 and 27 may each be of the optical or magnetic type. In what follows, the case of two sensors 26 and 27 of the magnetism-sensitive type will be envisaged.

The detection portion 7 comprises two annular encoders 28 and 29. The encoder 28 is in the shape of a multipole ring of elongated rectangular section radially attached, for example by bonding or by overmolding, to a radial face of the flexible gear 9, and facing the sensor 26 with a slight axial air gap. The encoder 28 being less rigid than the flexible element 9 is capable of following the radial deformations of said flexible gear 9 and of generating a magnetic signal in the sensor 26.

The encoder 28 and the gear 9 could form only one and the same single piece.

The encoder 29 is supported by the inner race 15 of the rolling bearing 6 and generates a magnetic signal in the sensor 27. The encoder 29 comprises a support 30, for example in the form of a metal sheet bush provided with an axial portion sleeve-fitted onto an outer bearing surface of the inner race 15, a radial portion in abutting contact against the front transverse radial face of the inner race 15 on the side of the reduction gear 5, and a smaller-diameter axial portion extending in the direction of the reduction gear 5, and an active portion 31, for example of the plastoferrite type, overmolded onto the support 29 surrounding the small-diameter axial portion and a part of the large-diameter axial portion and having an axial outer surface facing the sensor 27 with a small radial air gap.

In the embodiment shown, the rolling bearing 6 has no sealing flange on the side of the encoder 29. However, it would be possible to provide a friction seal or a flange of appropriate shape interacting with a portion of the encoder 29.

The detection portion 7 therefore comprises an electronic circuit board of the same type supporting two sensors and an electronic circuit receiving the output signals from said sensors and capable of transmitting to the outside, for example via a wire or wireless link not shown, an item of information representative of the absolute angular position of the shaft 2, and an item of information relative to the angle of deflection. The electronic circuit board 25 may transmit output signals from the sensors 26 and 27 after a simple formatting or, alternatively, carry out processing making it possible to determine with the desired precision the absolute angular position of the shaft 2 of the electric motor on the one hand, on the basis of the information supplied by the sensor 27 and, on the other hand, the angle of deflection of the vehicle wheels as a function of the output signal of the sensor 26 and of the output signal of the sensor 27.

The detection device 1 may therefore comprise a single rolling bearing, a reduction gear, two encoders, two sensors and a single electronic circuit board supporting the sensors, which is particularly economical and compact. In addition, the detection device 1 forms a subassembly which may be easily assembled on an end of the shaft 2 of the electric motor, for example between a steering column drive pinion and the casing, not shown, of the motor. This therefore uses a single and compact system to replace systems which, in the prior art, were distributed over the steering column and on the power assisted steering motor.

During operation, the shaft 2 of the electric motor is capable of rotating while driving the pinion 3, which actuates the wheel deflection device, the shaft 2 of the motor being mechanically connected with the wheel orientation system such that the reduction ratio between the angular movement of the shaft 2 of the motor and the angular movement of the steering column shaft is of the order of 10 to 20. The inner race 15 of the rolling bearing 6, and consequently the encoder 29, are driven at the same speed as the shaft 2. The angular movement of the shaft 2 is therefore detected by the sensor 27 and transmitted to the electronic circuit 25 for transmission to an outside member and, as appropriate, processing. The wave generator 10 of the reduction gear 5 is also driven at the same speed of rotation of the shaft 2, which rotates the flexible gear 9 with a reduction ratio of 5 to 100, preferably of the order of 40 to 80. In other words, the flexible gear 9 and the encoder 28 move one degree of angle for 40 to 80° of angle of movement of the shaft 2. The angular movement of the encoder 28 and of the flexible gear 9 is detected by the sensor 26 and transmitted to the electronic circuit 25 for transmission to an outside member and, as appropriate, processing.

In order to limit the angular movement of the flexible gear 9 and of the encoder 28 to less than one revolution, the gearing ratio of the reduction gear 5 is designed to be greater than or equal to the product of the gearing ratio of the shaft 2 relative to the steering column by the number of revolutions of the steering column from one stop to another, that is to say from the extreme position of deflection to the left to the extreme position of deflection to the right of the vehicle wheels. This ensures that the encoder 28 has a range of rotation of less than 360°. It is therefore possible to use an encoder 28 and a sensor 26 of the single-revolution type that is clearly more economical than a multirevolution sensor. The resolution of the sensor 26 and of the encoder 28 may be relatively low because the precise angular position of the shaft 2 is supplied by the sensor 27 and the encoder 29 while the sensor 26 and the encoder 28 provide only a less precise signal. Because of the gear reduction provided by the reduction gear 5, it is therefore possible to determine an angular position of the steering column with very great accuracy of the order of 0.1°.

The encoder 28 may be of the circumferentially alternate poles type or else of the four-pole type with an external north pole and an internal south pole on 180°, and an internal north pole and an external south pole on 180°. The magnetic field seen by the sensor varies according to the angular position and the radial position of the encoder 28 because of the radial deformation of the flexible gear 9.

To control the electric motor 2 which may be of the brushless direct current type, it is desirable to know with precision the angular position of the poles of the rotor and consequently of the shaft 2. The sensor 27 and the encoder 29 are of the multirevolution type with high resolution or else supplying an absolute angle.

In the embodiment shown, the casing 19 is designed to be nonrotating, for example fixedly attached in rotation to the casing of the electric motor while one of the encoders is associated with the inner race of the rolling bearing and the other with the flexible gear of the reduction gear. As a variant, the encoder 29 may be mounted on the axial annular portion 1 of the wave generator 10 or else directly on the shaft 2, which may make it possible to use a rolling bearing of the standard type with two sealing elements also of the standard type. This gives a reduction gear whose crown wheel may be designed to support the sensors, the rolling bearing ensuring the concentricity of the crown wheel and of the shaft of the electric motor.

For more clarity, the casing 32 of the electric motor and the steering column 33 have been illustrated in dashed lines in FIG. 1.

Thanks to the invention, the user has an extremely compact and economical device mounted as a subassembly onto an electric motor shaft of electric power assistance steering or of fully electric steering and furnished with an electronic circuit board supplying both a signal representing the precise angular position of the electric motor shaft and a signal representing the angle of deflection of the wheels. Two sensors only may suffice to supply these data. In addition, it is possible to dispense with other additional detection systems, for example placed on a steering column rolling bearing or else on a steering rack.

It would also be possible, without departing from the context of the invention, to provide a reduction gear of the epicyclic type instead of a reduction gear of the harmonic type.

1. A device for detecting the angular position of a shaft of an electric motor relative to a nonrotating element, comprising:
a reduction gear including an input connected in rotation to the shaft and an output, the gear being configured such that the output of the reduction gear moves through an angle of less than 2π,
a single-revolution angular position sensor configured to measure the angle of the reduction gear output, and
an angular position sensor disposed on the reduction gear input.

2. The device as claimed in claim 1, wherein the reduction ratio of the reduction gear is chosen to be between 5 and 100.

3. The device as claimed in claim 1, wherein the single-revolution sensor is an absolute angular position sensor.

4. The device as claimed in claim 1, wherein the single-revolution sensor is mounted on an electronic circuit board supported by a casing of the reduction gear.

5. The device as claimed in claim 1, wherein the reduction gear comprises at least one epicyclic train or at least one harmonic reduction gear.

6. The device as claimed in claim 1, wherein the reduction gear includes a rolling bearing and a casing, the rolling bearing including an inner race mounted on the shaft and an outer race (16) mounted in the casing, and the device further comprises an encoder supported by the inner race and interacting with the angular position sensor.

7. The device as claimed in claim 6 wherein at least one of:
the angular position sensor is disposed radially outside the encoder, and
the single-revolution angular position sensor has an axial air gap with an encoder.

8. The device as claimed in claim 1, wherein the single-revolution angular position sensor is placed radially outside the angular position sensor.

9. The device as claimed in claim 1, wherein the angular position sensor is configured to measure a modulo 2π angle.

10. An electric motor comprising:
a rotor,
a stator and
a device for detecting the angular position of a shaft of an electric motor relative to a nonrotating element, the device including a reduction gear having an input connected in rotation to the shaft and an output, such that the output of the reduction gear moves over an angle of less than 2π, a single-revolution angular position sensor configured to measure the angle of the reduction gear output, and an angular position sensor disposed on the reduction gear input, the rotor being connected to the input of the reduction gear.

11. The electric motor as claimed in claim 10, in combination with a power assisted steering device including a shaft driven by the electric motor and designed to steer the wheels of a vehicle.

12. A reduction gear comprising:
a reduction mechanism,
an input and an output,
a single-revolution angular position sensor placed to measure the angle of the output, the reduction ratio of the reduction gear being chosen such that the output of the reduction gear moves over an angle of less than 2π, and
an angular position sensor on the input of the reduction gear.

13. The reduction gear as claimed in claim 12, including a single rolling bearing.
